(19) United States
(12) Patent Application Publication
(10) Pub. No.: US 2022/0118772 A1
(43) Pub. Date: Apr. 21, 2022

(54) USING PUMP ON-TIMES TO DETERMINE FLUID LEVELS

(71) Applicant: Hewlett-Packard Development Company, L.P., Spring, TX (US)

(72) Inventors: Matthew J. Janssen, Corvallis, OR (US); James R. Cole, Corvallis, OR (US)

(73) Assignee: Hewlett-Packard Development Company, L.P., Spring, TX (US)

(21) Appl. No.: 17/431,316

(22) PCT Filed: Jun. 28, 2019
(86) PCT No.: PCT/US2019/039910

§ 371 Date: Aug. 16, 2021

(51) Int. Cl. B41J 2/175

(52) U.S. Cl. CPC B41J 2/17596; B41J 2/17556; B41J 2/17566

(57) ABSTRACT

In one example in accordance with the present disclosure, a method of determining a printing fluid level is described. According to the method, an on-time of a pump is determined. The pump maintains a fixed pressure in a pressurized reservoir. From the on-time, a fluid level in the pressurized reservoir is determined.

### BACKGROUND

Fluid ejection systems are used for a variety of purposes including printing text and images on media. A fluid ejection system may include a reservoir containing the fluid to be ejected by the fluid ejectors.

Monitoring the amount of ejection fluid in the reservoir may be accomplished in a variety of methods. For example, it is possible to count the number of times the fluid ejectors fire and estimate the fluid consumption. It is also possible to include a level sensor in the reservoir and measure the fluid level directly.

Monitoring the amount of fluid may be used to provide notice to a user when the fluid level is low. This allows the user to replenish the fluid for the ejection system. In some examples, monitoring the amount of fluid allows the user to estimate the time until replenishment will be needed and plan ahead to have supplies on hand.

### BRIEF DESCRIPTION OF THE DRAWINGS

The accompanying drawings illustrate various examples of the principles described herein and are a part of the specification. The illustrated examples do not limit the scope of the claims.

FIG. 1 shows a flowchart for a method of determining a fluid level in an example consistent with this specification.

FIG. 2 shows an inverse, linear relationship between on-time and fluid level in a pressurized reservoir in an example consistent with this specification.

FIG. 3 shows an example of a system for measuring fluid level in an example consistent with this specification.

FIG. 4 shows a flowchart of a method of measuring a fluid level in a pressurized reservoir in an example consistent with this specification.

Throughout the drawings, identical reference numbers designate similar, but not necessarily identical, elements. The figures are not necessarily to scale, and the size of some parts may be exaggerated or minimized to more clearly illustrate the example shown. The drawings provide examples and/or implementations consistent with the description. However, the description is not limited to the examples and/or implementations shown in the drawings.

### DETAILED DESCRIPTION

Fluid ejection systems, such as printers, may include a reservoir to store printing fluid. Such a reservoir may be located in a pen. The pen may include a reservoir and a print die. The reservoir may be located elsewhere in the system and feed the pen. In some examples, the reservoir is pressurized. Pressurization may help provide control of the fluid flow in the fluid ejection system.

Pressurization of the printing fluid reservoir may be maintained using a pump. The pump may have a duty cycle where the pump is on for a period of time and off for a period of time. In some examples, the duty cycle is controlled by a pressure sensor. When the pressure in the reservoir drops below a threshold, the pump activates and increases the pressure until the pressure is above a second threshold. The pressure in the reservoir may drop over time, causing the pump to activate periodically. In some examples, use of the printing fluid in the reservoir increases the rate of pump activation.

The on-time of the pump may be used to estimate an amount of fluid in the reservoir. When the reservoir is full, the on-time is low. As the fluid level in the reservoir decreases, the on-time increases. In some examples, the relationship between on-time and fluid level in the reservoir is linear. The relationship between the on-time and the fluid level have an inverse relationship, with higher fluid levels associated with shorter on-times and lower fluid levels associated with longer on-times. This can be thought of as a relationship between gas volume in the reservoir and on-time for the pump. Larger volumes of gas require a longer time for the pump to change the pressure from the lower pressure threshold to the higher pressure threshold. If the pump volume per unit time is kept constant then the relationship may be linear.

Once the relationship between a pump on-time and the fluid level in the reservoir is characterized, this relationship may then be used to estimate the fluid level in the reservoir. This approach does not require a level sensor in the fluid reservoir.

The pump on-time is the time required to pump the pressurized reservoir from the lower threshold to the upper threshold. This may be represented as a change in pressure. The volume is the gas volume in the reservoir. The gas volume is the total volume minus the liquid volume in the reservoir. Since the change in pressure is small, the non-linearity from compressing the gas may not impact the performance.

Note that the measurement is not dependent upon how often the pressure needs to be refilled. Instead, it relies on the pump flow rate value and the pressure range between pump on and pump off. Assuming reproducible hysteresis in the pump turn on and turn off signals, the result is a measure that is linear compared with gas volume in the pressurized reservoir, and inversely linear compared with the remaining fluid volume in the reservoir.

As the measure is based on the pump on-time when pressurizing the pressurized reservoir, it follows that during use, when the volume of liquid is decreasing, the pressure will need to be provided and additional measurements can be made. Thus, the system will provide more frequent data on fluid levels when those fluid levels are changing.

Among other examples, this specification describes a method of determining a printing fluid level including: determining an on-time of a pump, wherein the pump maintains a fixed pressure in a pressurized reservoir; and determining from the on-time, a fluid level in the pressurized reservoir.

Among other examples, this specification also describes a fluid ejection system including: a reservoir to contain ejection fluid; a pressure sensor to measure a pressure in the reservoir; and a pump to maintain the pressure in the reservoir, wherein an on-time of the pump is inversely proportional to the amount of fluid in the reservoir.

This specification also describes a method of assessing a level of printing fluid, the method includes: measuring a pump on-time for a pump used to maintain a pressure of a pressurized reservoir; and calculating a fluid level in the pressurized reservoir from the measured pump on-time wherein the fluid level is linearly and inversely proportional to the pump on-time.

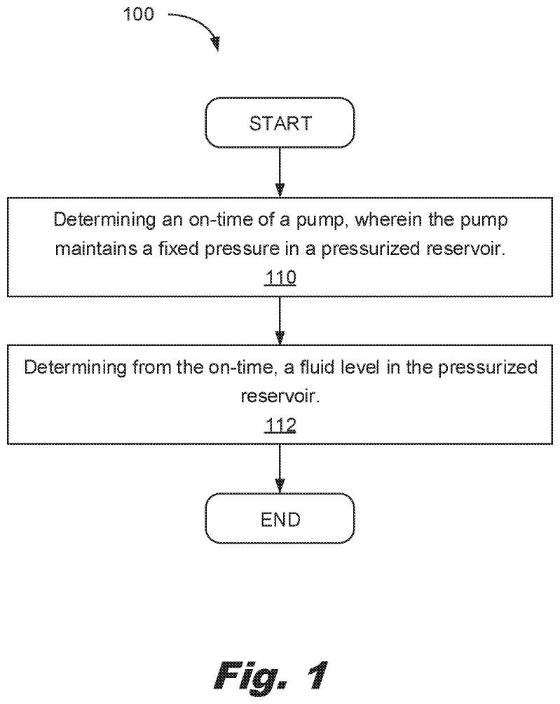

Turning now to the figures, FIG. 1 shows a flowchart for a method (100) of determining a printing fluid level in an example consistent with this specification.

The method (100) includes determining (110) an on-time of a pump, wherein the pump maintains a fixed pressure in a pressurized reservoir. In an example, the power line for the pump is monitored. When the power level is sufficient to activate the pump, the on-time may be accumulated. In an example, a signal line from a pressure sensor is monitored. Here on-time may be measured based on the signal on the signal line with the pressure above a setpoint indicating accumulation of on-time until the pressure passes a second set point. The pressure sensor itself may be monitored. The output of a comparator which compares the pressure sensor to a fixed pressure may be monitored. The ground line for the pump may be monitored.

In an example, the on-time for the pump is measured as a moving average over a number of pump-on cycles. Measuring on-time over a number of pump-on cycles allows signal averaging which may allow more accurate estimates of the residual fluid level in the reservoir. In an example, the moving average averages five pump-on cycles. Clearly, other numbers of cycles, e.g., 2, 3, 4, 6, etc. may be used without departing from the scope of the disclosure.

The method (100) also includes determining (112), from the pump on-time, a fluid level in the pressurized reservoir. In an example, just the on-time is used in calculating the fluid level in the pressurized reservoir. The constants may be stored in a memory. The constants may be individualized to the particular pump. The constants may be generalized to a type of pump. The constants may be independent of the shape of the pressurized chamber. In an example, a system determines the fluid full level from the newly loaded cartridge and uses that as the initial value. The system may have a lookup table to estimate the fluid remaining. For example, the lookup table may include a mapping between pump on time and fluid level. Accordingly, once a pump on-time is determined, a fluid level can be determined relying on this mapping. The system may also have a slope reflecting the pump performance and use the initial value and the slope to calculate the remaining fluid volume. In this example, the fluid consumed may be defined as mX +b where m is a slope based on the pump and b is calculated from the as-loaded condition, i.e., when the reservoir is first filled with printing fluid.

In an example, the method (100) further includes looking up constants in a lookup table. The relationship between on-time and fluid level is an inverse relationship. The relationship between on-time and fluid level may be a linear relationship. For a linear relationship, the use of a slope and an intercept may be used, along with the on-time, to calculate the fluid level of the reservoir.

Accuracy of the measurement depends upon the repeatability of the pump-on and pump-off signals. The signals need not be exact but rather should turn on and off at the same point each cycle. Linear volume per time for the pump also factors into the linearity of the output. If the pump performance is non-linear, then, depending on the amount of non-linearity and volumes involved, there may be non-linear output in the pump on-time to printing fluid volume relationship which needs to be accounted for. Also, the pump on-time should be measured accurately as any inaccuracy in pump on-time will impact the measured fluid volume remaining. The limited numbers of factors which impact the performance of this measurement make the measurement robust and readily implemented.

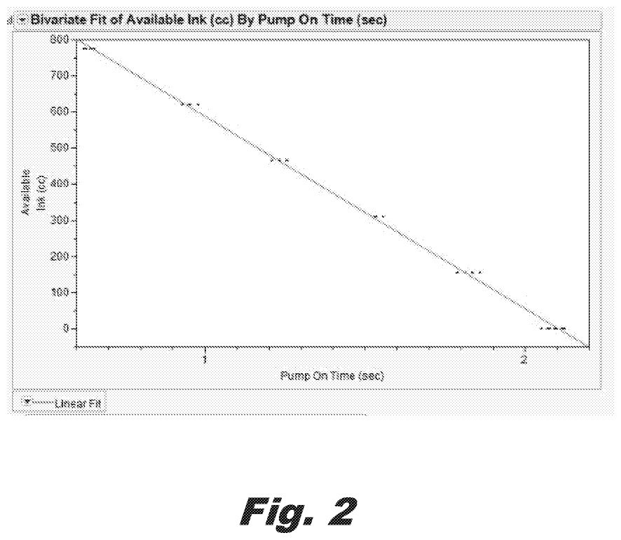

FIG. 2 shows plotted data comparing on-time for the pump with fluid volume in a pressurized reservoir. The y axis shows the fluid volume in the reservoir in cubic centimeters. The x axis shows the on-time of the pump in seconds. As indicated above, in some examples, the relationship between the two factors is linear. Accordingly, measuring the on-time for the pump can be used to estimate the residual fluid volume in the pressurized reservoir.

The data in the graph of FIG. 2 was generated by loading different cartridges with different amounts of printing fluid and then measuring the pump on time for the various cartridges. Accordingly, it reflects cartridge to cartridge variation as well, further strengthening the robustness of the approach to estimating fluid levels in the reservoir. The resolution of the pump on-time is a factor in the accuracy of the estimate of fluid level. However, a variety of methods exist to measure on-time economically and accurately. For example, the pump control line may be monitored or the sensor output from the pressure sensor may be monitored.

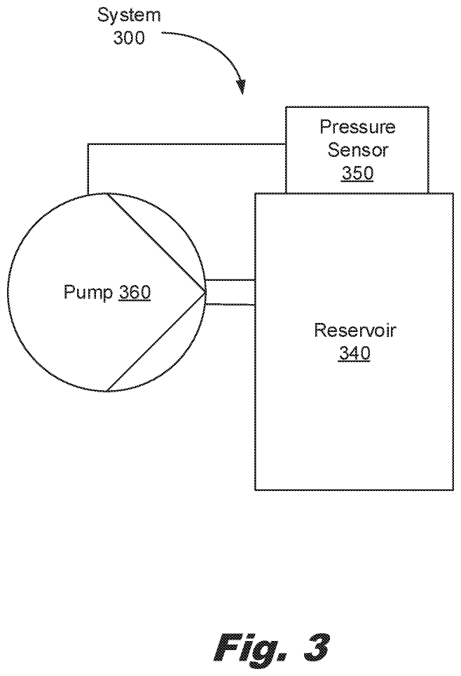

FIG. 3 shows a system (300) for measuring fluid level in a pressurized reservoir (340) according to an example consistent with the present specification.

The system (300) measures the fluid level in the pressurized reservoir (340) using the on-time of the pump (360). The on-time measurement may then be converted into a fluid volume as discussed above. In an example, the pressure sensor (350) is used to monitor the on-time of the pump (360) by monitoring the change in pressure as the system (300) is pressurized by the pump (360). In some examples, an additional sensor is used to measure the on-time of the pump (360). The additional sensor may monitor the pump power line and/or control line. The additional sensor may look at the output of the pressure sensor (350). The additional sensor may monitor the result of the pressure sensor (350) and a comparator. The comparator may compare the result of the pressure sensor against a control value. The comparator may compare the result of the pressure sensor against a fixed pressure.

In some examples, the geometry of the reservoir (340) does not impact the results beyond the variation in volume of the reservoir (340). Because the described measurement is a change in pressure over a volume, the shape of the volume does not impact the determination, as long as there are no bottlenecks or similar features in the reservoir (340). This allows a variety of different pressurized reservoir shapes to be managed with this approach without having to adjust for differences in cross-section with height, for example. In some examples, the printing fluid is in a bag with an uncontrolled shape, which bag is disposed in the reservoir (340). Again, as the measurement is based on volume, not geometry, this does not impact the ability to measure the remaining fluid volume in the reservoir (340).

In some examples, the reservoir (340) includes a bag, such as a polymer bag, containing the printing fluid. The pressure is built up around the bag in the reservoir (340) exerting pressure on the printing fluid in the bag. The use of a bag may also facilitate loading and/or replacing the printing fluid in the reservoir (340).

The pressure sensor (350) measures the pressure in the reservoir (340). The pressure sensor (350) provides the signal to control the pump (360) cycle. That is, the pressure sensor provides the signal to both turn the pump (360) on when the pressure is too low and turn the pump (360) off when the pressure is adequate. The pressure sensor (350) may be a piezo-electric pressure sensor (350). The pressure sensor (350) may be a mechanical pressure sensor. The pressure sensor (350) may be a digital pressure sensor. Strain based, capacitive, optical, potentiometric, force-balancing, and/or other types of pressure sensors (350) may also be used. The disclosure is not limited to a particular type of pressure sensor (350). In an example, the pressure sensor (350) may have a membrane between the pressure sensor (350) and the reservoir (340).

The pump (360) pressurizes the reservoir (340) under the control of the pressure sensor (350). The on-time of the pump (360) is used to calculate the fluid level in the reservoir (340). In some examples, the on-time of the pump (360) is controlled in small enough increments so as to provide a meaningful measurement of the pump on-time. This will depend on the size and type of the pump (360) relative to gas volume in the reservoir (340). Accordingly, accurate measurements may be more challenging when the reservoir (340) is full of printing fluid, depending on the type and size of the pump (360) selected.

In some examples, signal averaging of a number of pump-on cycles will provide more accurate measurement of the fluid volume, especially when the pump (360) has a large step size. In such instances, signal averaging may be used to improve the quality of the measurement.

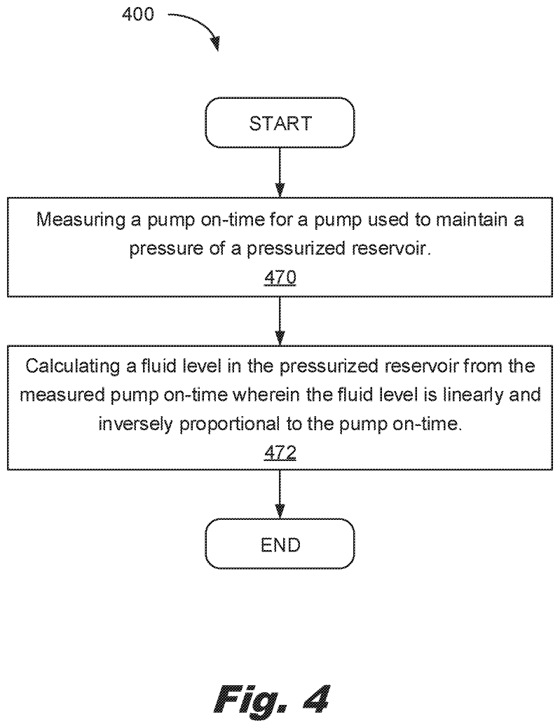

FIG. 4 shows a flowchart of a method (400) of measuring a fluid level in a pressurized reservoir in an example consistent with this specification.

The method (400) includes measuring (470) a pump (360) on-time for a pump (360) used to maintain a pressure of a pressurized reservoir (340). In some examples, the on-time is measured as part of a moving average. The pump (360) on-time may be measured in units of seconds. The pump (360) on-time may be controlled by a pressure sensor (350) which monitors the pressure in the pressurized reservoir (340). When the pressure drops below a first pressure, the pump (360) is activated until the pressure rises above a second pressure. The first pressure may be the second pressure. Alternately, a range may be selected between the first pressure and second pressure. In an example, the range is approximately 10% of the first pressure. Other values, e.g., 5%, 20%, may similarly be used.

In an example, measuring the pump (360) on-time includes measuring a voltage on a power line for the pump (360). For example, the power line may go high when the pump is active (on). Measuring the pump (360) on-time may include measuring a control line for the pump (360). The control line may go high or low when the pump is active (on). Measuring the pump (360) on-time may include measuring a moving average pump (360) on time for the pump (360). In some examples, the moving average allows an improved estimate (higher accuracy, greater reliability) compared to using single measurements to estimate fluid levels.

The method (400) includes calculating (472) a fluid level in the pressurized reservoir (340) from the measured pump (360) on-time wherein the fluid level is linearly and inversely proportional to the pump (360) on-time. The calculation may involve a slope based on the pump performance and a fixed point. In an example, the fixed point is determined from the fresh cartridge condition for the system (300) and corresponds to a condition of zero cubic centimeters (cc) of printing fluid consumed. In other examples, the fixed point is provided with the cartridge. In an example, the cartridge includes performance information about a pressure-volume behavior. This information may be stored in a memory.

It will be appreciated that, within the principles described by this specification, a vast number of variations exist. It should also be appreciated that the examples described are only examples, and are not intended to limit the scope, applicability, or construction of the claims in any way.

What is claimed is:

1. A method of determining a printing fluid level comprising:
determining an on-time of a pump, wherein the pump maintains a fixed pressure in a pressurized reservoir; and
determining, from the on-time of the pump, a fluid level in the pressurized reservoir.

2. The method of claim 1, wherein the fluid level and the on-time of the pump have an inverse linear relationship.

3. The method of claim 1, wherein determining, from the on-time of the pump, a fluid level in the pressurized reservoir comprises consulting a look up table.

4. The method of claim 1, wherein the on-time is measured as a moving average.

5. The method of claim 1, wherein the on-time is measured on a power line to the pump.

6. The method of claim 1, wherein the on-time is measured on a control signal for the pump.

7. A fluid ejection system comprising:
a reservoir to contain ejection fluid;
a pressure sensor to measure a pressure in the reservoir; and
a pump to maintain the pressure in the reservoir, wherein an on-time of the pump is inversely proportional to the amount of ejection fluid in the reservoir.

8. The fluid ejection system of claim 7, further comprising a second sensor to measure the on-time of the pump.

9. The fluid ejection system of claim 8, wherein the second sensor is an electrical sensor.

10. The fluid ejection system of claim 7, wherein the pressure sensor is used to measure the pump on-time.

11. The fluid ejection system of claim 7, wherein the pump on-time is measured as a moving average.

12. A method of assessing a level of printing fluid, the method comprising:
measuring a pump on-time for a pump used to maintain a pressure of a pressurized reservoir; and
calculating a fluid level in the pressurized reservoir from the measured pump on-time, wherein the fluid level is linearly and inversely proportional to the pump on-time.

13. The method of claim 12, wherein measuring the pump on-time comprises measuring a voltage on a power line for the pump.

14. The method of claim 12, wherein measuring the pump on-time comprises measuring a potential on a control line for the pump.

15. The method of claim 12, wherein measuring the pump on-time comprises measuring a moving average pump on-time for the pump.
